(19) United States
(12) Patent Application Publication
(10) Pub. No.: US 2024/0288894 A1
(43) Pub. Date: Aug. 29, 2024

(54) BURIED ZENER DIODE VOLTAGE REFERENCE WITH DIGITAL CORRECTION

(71) Applicant: TEXAS INSTRUMENTS INCORPORATED, Dallas, TX (US)

(72) Inventors: Chienyu HUANG, Plano, TX (US); Peng CAO, Allen, TX (US); Kevin SCOONES, San Jose, CA (US); Vishnu Vardhan RAVINUTHULA, Dallas, TX (US); Bumkil LEE, Allen, TX (US)

(21) Appl. No.: 18/175,208

(22) Filed: Feb. 27, 2023

(51) Int. Cl. G05F 3/18; G05F 1/46

(52) U.S. Cl. CPC G05F 3/18; G05F 1/468

(57) ABSTRACT

In an example, a system includes a buried Zener diode having a first terminal coupled to a voltage terminal. The system also includes a first resistor having a first terminal coupled to a second terminal of the buried Zener diode. The system includes a second resistor having a first terminal coupled to a second terminal of the first resistor. The system also includes a first transistor having a control terminal coupled to the first terminal of the second resistor. The system includes a second transistor having a control terminal coupled to a second terminal of the second resistor and an emitter coupled to an emitter of the first transistor. The system also includes a resistor network coupled to the second terminal of the first resistor, where the resistor network is configured to produce a reference voltage.

### BACKGROUND

Batteries provide power for a variety of applications, including electric or hybrid electric vehicles. A battery pack may include multiple battery cells. A battery monitor or battery monitoring system may monitor information associated with the cells, such as temperature, voltage, and other indicators of cell status and health, for vehicular safety and to ensure proper operation.

### SUMMARY

In accordance with at least one example of the disclosure, a system includes a buried Zener diode having a first terminal coupled to a voltage terminal. The system also includes a first resistor having a first terminal coupled to a second terminal of the buried Zener diode. The system includes a second resistor having a first terminal coupled to a second terminal of the first resistor. The system also includes a first transistor having a control terminal coupled to the first terminal of the second resistor. The system includes a second transistor having a control terminal coupled to a second terminal of the second resistor and an emitter coupled to an emitter of the first transistor. The system also includes a resistor network coupled to the second terminal of the first resistor, where the resistor network is configured to produce a reference voltage.

In accordance with at least one example of the disclosure, a system includes an analog front end configured to receive a battery voltage. The system also includes a reference voltage generator configured to generate a reference voltage with a buried Zener diode and a difference in base-emitter voltages between a first transistor and a second transistor. The system includes an analog-to-digital converter (ADC) configured to receive the battery voltage and compare the battery voltage to the reference voltage to produce a digitized result. The system also includes a controller configured to receive the digitized result from the ADC and perform a digital correction, where the digital correction includes a gain correction and an offset correction of the ADC, and where the digital correction includes a correction for the reference voltage.

In accordance with at least one example of the disclosure, a method includes receiving a battery voltage at an analog front end. The method also includes generating a reference voltage with a buried Zener diode and a difference in base-emitter voltages between a first transistor and a second transistor. The method includes comparing the battery voltage to the reference voltage with an ADC. The method also includes performing a second order digital correction for a gain error of the ADC. The method includes performing a second order digital correction for an offset error of the ADC. The method also includes performing a third order digital correction for the reference voltage.

### BRIEF DESCRIPTION OF THE DRAWINGS

FIG. 1A is a block diagram of a battery monitor in accordance with various examples.

FIG. 1B is a block diagram of a controller in accordance with various examples.

FIG. 2 is a diagram of a circuit for producing a reference voltage in accordance with various examples.

FIG. 3 is a block diagram of a digital correction process in accordance with various examples.

FIG. 4 is a second order digital correction in accordance with various examples.

FIG. 5 is a third order digital correction in accordance with various examples.

FIG. 6 is a graph showing reference drift after correction in accordance with various examples.

FIG. 7 is a block diagram of a battery monitoring system in accordance with various examples.

FIG. 8 is flow diagram of a method for performing digital correction of a buried Zener diode-based reference in accordance with various examples.

The same reference numbers or other reference designators are used in the drawings to designate the same or similar (functionally and/or structurally) features.

### DETAILED DESCRIPTION

A battery pack may include multiple battery cells and a monitor that measures the voltages of each of the cells. A reference voltage is generated, and the battery monitor monitors the battery voltages by comparing them to the reference voltage. The accuracy of the battery monitor is a metric that is observed for proper operation. One system for generating a reference voltage is a bandgap voltage reference circuit, commonly referred to as a bandgap reference or a bandgap voltage reference. A bandgap voltage reference includes circuitry that balances the negative temperature coefficient of a PN junction with the positive temperature coefficient of the thermal voltage Vt. In one example, circuitry generates an output voltage that is proportional to absolute temperature (PTAT) by using two transistors (such as bipolar junction transistors (BJT)) that have different emitter areas. Then, this output voltage with a positive temperature coefficient may be summed with a voltage that has a negative temperature coefficient, such as a base-emitter voltage (V_{BE}) of a BJT. The sum of the two voltages produces a reference voltage that only varies slightly with temperature over a certain temperature range.

In such solutions, the accuracy of the reference voltage may be limited by reference temperature drift. The accuracy of the reference voltage may also be limited when circuitry is covered by a semiconductor package and soldered to conductive members within the package. A silicon die experiences stress after packaging and soldering, and the reference voltage is sensitive to that stress.

In examples described herein, a battery monitoring system includes a combination of analog and digital circuitry. Rather than a traditional BJT bandgap voltage reference as described above, a buried Zener diode is used as a reference. A buried Zener diode is a Zener diode that has a breakdown region in a subsurface layer or buried in an integrated circuit, rather than a breakdown region at or near the surface of the integrated circuit. The base-emitter junction of the diode may be buried under the surface of the integrated circuit. The buried Zener diode and the associated circuitry form the analog portion of the system. The digital portion of the system includes circuitry configured to perform a second order or third order digital correction. The combination of analog and digital circuitry provides improved temperature drift compared to the prior solutions described above. Furthermore, a buried Zener diode has better resistance to package stress than a BJT because the buried Zener diode is less susceptible to displacement than the BJT reference during the packaging process.

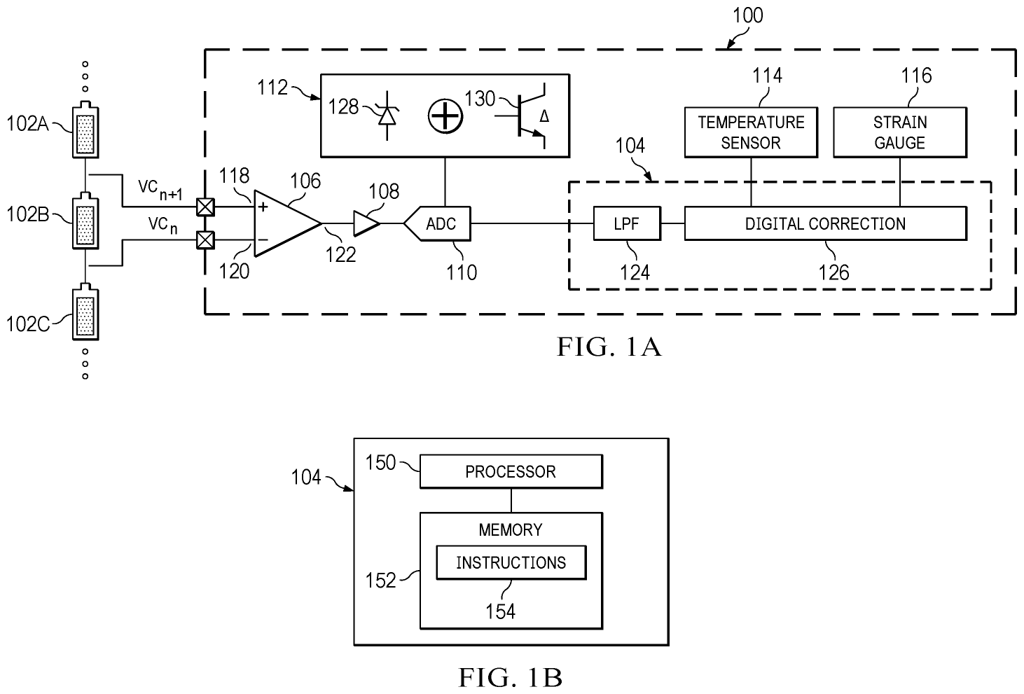

FIG. 1A is a block diagram of a battery monitor 100 in accordance with various examples herein. Battery monitor 100 may be a stackable battery monitor that can monitor multiple battery cells, such as 18 battery cells in one example. Example battery cells 102A, 102B, and 102C (collectively, battery cells 102) are shown coupled to the battery monitor 100. Battery monitor 100 includes a digital controller 104, an analog front end (AFE) 106, a buffer 108, and an analog-to-digital converter (ADC) 110. Battery monitor 100 also includes a reference 112, a temperature sensor 114, and a strain gauge 116. In some examples, multiple battery monitors 100 may share some of the components in FIG. 1A, such as the reference 112, temperature sensor 114, and strain gauge 116.

AFE 106 includes a first input 118, a second input 120, and an output 122. The internal circuitry of AFE 106 is not shown in detail herein. AFE 106 includes any suitable circuitry to perform the functions described herein. Digital controller 104 includes a low pass filter (LPF) 124 which reduces high frequency error, and a digital correction block 126 which performs second order and/or third order digital correction in one example. Reference 112 includes a buried Zener diode 128 and a delta voltage reference 130. In battery monitor 100, digital controller 104 provides the digital portion of the system, while the rest of battery monitor 100 provides the analog portion of the system.

In one example, AFE 106 is a high voltage AFE that converts the high voltage of the battery cells to a low voltage domain. AFE 106 measures a voltage across a battery cell by receiving a voltage VCₙ₊₁ at first input 118 and a voltage VCₙ at second input 120, and providing the difference between the voltages at output 122. The output signal of AFE 106 is provided to ADC 110 through a buffer 108. ADC 110 receives the output signal of AFE 106 and compares it to a reference voltage from reference 112. ADC 110 then provides a digital output to digital controller 104. The digital output represents the difference between the output of AFE 106 and the reference voltage from reference 112. The digital output is provided to LPF 124. LPF 124 filters the digital output to remove high frequency noise in one example. The digital correction performed by digital correction block 126 may be a second order correction. A second order correction uses data collected at three different temperatures (e.g., 3-temperature data) to perform the correction. The digital correction may also be a third order correction that uses 4-temperature data (e.g., data collected at four different temperatures). The digital correction may use a temperature reading from temperature sensor 114 in one example. The digital correction may also use a strain reading from strain gauge 116, although that example is not described herein. A strain gauge may detect deformation or stress on a printed circuit board.

As described above, by using a buried Zener diode 128 in reference 112 rather than a BJT reference, the battery monitor 100 has better resistance to package stress and temperature drift. Also, the second order or third order digital correction does not introduce any new error and can achieve accurate results with respect to temperature drift. In one example, the system described herein can achieve ±0.8 millivolt accuracy on a 4V scale, which is ±0.02% accuracy.

FIG. 1B is a block diagram of a digital controller 104 in accordance with various examples herein. Digital controller 104 includes a processor 150 and memory 152 in this example. Digital controller 104 may include one or more processors 150 and one or more memories 152 in other examples. Memory 152 may include any suitable data, code, logic, or instructions 154. The processor 150 is configured to read and execute computer-readable instructions. For example, the processor 150 is configured to invoke and execute instructions in a program stored in the memory 152, including instructions 154. Instructions 154 may perform the actions described herein, such as filtering the signal with LPF 124 or providing a digital correction.

In an example, the memory 152 may be integrated with the processor 150. The memory 152 is configured to store various software programs and/or multiple groups of instructions, including the instructions 154. The memory 152 is configured to store the instructions 154 for implementing the various methods and processes provided in accordance with the various examples of this description.

In another example, elements of digital controller 104 disclosed herein may use any combination of dedicated hardware and instructions stored in a non-transitory medium, such as memory 152. The non-transitory medium includes all electronic mediums or media of storage, except signals. Processor 150 may include one or more microcontrollers, application-specific integrated circuits (ASICs), CPUs, graphics processing units (GPUs), and/or other processing resources configured to execute instructions 154 stored on the medium. Examples of suitable non-transitory computer-readable media include one or more flash memory devices, battery-backed RAM, solid state drives (SSDs), hard disk drives (HDDs), optical media, and/or other memory devices suitable for storing the instructions 154 for the processor 150.

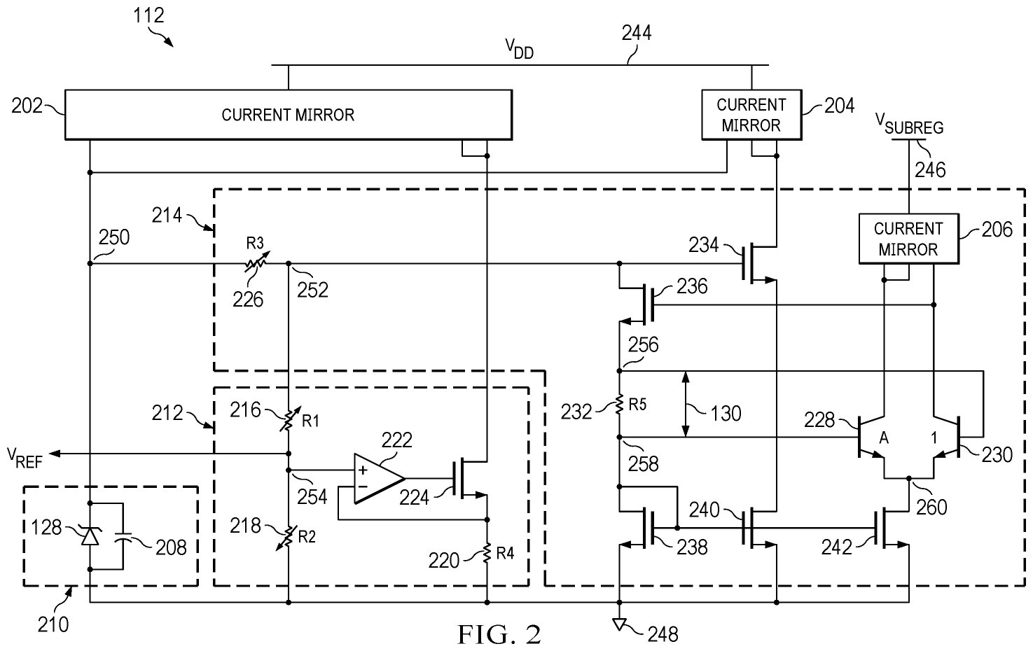

FIG. 2 is a diagram of a circuit for producing a reference voltage in accordance with various examples herein. Reference 112 produces a reference voltage with a buried Zener diode 128 and a delta voltage reference 130 provided by two BJTs.

Reference 112 includes multiple current mirrors to provide bias currents to various circuit components, such as current mirrors 202, 204, and 206. For example, current mirror 202 provides currents to buried Zener diode 128 and to a drain of transistor 224. Current mirror 204 provides currents to transistors 224 and 230. Current mirror 206 provides currents to transistors 228 and 230, which help to provide the delta voltage reference 130 in this example. Reference 112 includes a capacitor 208 coupled across buried Zener diode 128. Buried Zener diode 128 and capacitor 208 form Zener reference 210. Reference 112 includes a voltage divider 212 and a delta voltage reference generator 214.

Voltage divider 212 is a resistor network that includes a resistor R1 216, resistor R2 218, resistor R4 220, amplifier 222, and transistor 224. The components of voltage divider 212 produce a reference voltage V_{REF} based on the value of resistors R1 216 and resistor R2 218. Resistor R4 220, amplifier 222, and transistor 224 provide a bias current for voltage divider 212.

Delta voltage reference generator 214 includes a resistor R3 226, transistor 228, and transistor 230. Delta voltage reference generator 214 also includes resistor R5 232 and transistors 234, 236, 238, 240, and 242. Delta voltage reference generator 214 also includes current mirror 206. Current mirror 206 and transistors 234, 236, 238, 240, and 242 provide bias currents and voltages for transistors 228 and 230, which produce the delta voltage reference 130. The delta voltage reference 130 is subtracted from the Zener diode voltage to produce a Zener-based reference voltage that is relatively constant across temperature.

Reference 112 includes a voltage terminal 244 that provides a supply voltage VDD, and a voltage terminal 246 that provides another supply voltage V_{SUBREG}. Reference 112 also includes a ground terminal 248. Reference 112 also includes a number of labeled nodes, such as nodes 250, 252, 254, 256, 258, and 260.

In one example, buried Zener diode 128 provides a Zener voltage of about 6 V at node 250. Other Zener voltage values may be useful in other examples. A Zener voltage of 6 V is useful here to produce a desired reference voltage V_{REF}. Capacitor 208 may filter noise across Zener diode 128 in one example. Transistors 228 and 230 have a size ratio of A:1, and are BJTs with their emitters coupled together at node 260 as shown. The value for A may be 2, 5, 10, or any suitable value in other examples. Transistors 228 and 230 provide the delta voltage reference 130 across resistor R5 232. That is, the difference between the voltages at nodes 256 and 258 is the difference between the base-emitter voltages of transistors 228 and 230. The base terminal (e.g., control terminal) of transistor 228 is coupled to node 258 and resistor R5 232. The base terminal (e.g., control terminal) of transistor 230 is coupled to node 256 and resistor R5 232. The collectors of transistor 228 and transistor 230 are coupled to current mirror 206. Delta voltage reference 130 across resistor R5 232 therefore provides a difference in base-emitter voltages (e.g., a delta V_{BE}). This delta V_{BE} is PTAT. Delta voltage reference 130 and the Zener voltage across buried Zener diode 128 are both proportional to temperature, but they have different temperature coefficients. The delta voltage reference 130 is proportional to temperature because the base-emitter voltages of transistors 228 and 230 are linear functions of the absolute temperature. The Zener voltage across Zener diode 128 is also proportional to temperature due to the properties of its pn junction. Therefore, because the temperature coefficients are different, these voltages may be used to create a reference voltage that is largely independent of temperature variations via the circuitry described herein.

To provide reference voltage V_{REF} at node 254, the Zener voltage is provided at node 250 and a voltage drop occurs across resistor R3 226. Resistor R3 226 may be a first resistor that has a first terminal coupled to Zener diode 128 (e.g., node 250) and a second terminal coupled to the resistor network of voltage divider 212 (e.g., to resistor R1 216). Resistor R3 226 is also coupled to resistor R5 232 through transistor 236. The Zener voltage across buried Zener diode 128 and the delta voltage reference 130 together produce a voltage at node 252 that is relatively constant across temperature. A small voltage drop may also occur across transistor 236. This is because the delta voltage reference 130 and the Zener voltage across buried Zener diode 128 are both proportional to temperature but have different temperature coefficients, and so the voltage at node 252 has a low temperature dependence, as described with respect to equation (1) below. Using the relatively temperature independent voltage at node 252, the voltage divider of resistor R1 216 and resistor R2 218 provides any desired V_{REF} at node 254, such as 4 V in one example.

V_{REF} may be defined using equation (1):

$$VREF = [ VZ - {V}_{T} * ln ( A ) * \frac{R 3}{R 5} ] * \frac{R 2}{R 1 + R 2 + R 3} \qquad ( 1 )$$

In equation (1), V_{REF} is the voltage reference provided at node 254. VZ is the Zener voltage (provided at node 250) and V_{T} is the thermal voltage (e.g., about 27 mV) of transistors 228 and 230. A is the ratio of the size of transistor 228 to the size of transistor 230. R1, R2, R3, and R5 are the values of the associated resistors in FIG. 2. In equation (1), the

$$VZ - {V}_{T} * ln ( A ) * \frac{R 3}{R 5}$$

portion removes the temperature dependence of the voltages. This portion of equation (1) represents the voltage at node 252. The second portion of equation (1) (e.g., the resistor ratio

$$\frac{R 2}{R 1 + R 2 + R 3}$$

) represents the voltage divider 212, which provides the reference voltage V_{REF} at node 254. The adjustable resistors R1 216, R2 218, and R3 226 may be selected to set the value of V_{REF} based on system requirements and/or test data.

The Zener voltage may have some linear drift proportional to temperature (PTAT). This is first order drift, and first order drift may be removed with trimming the device by trimming R3 226. For second or third order reference drift, a digital correction may be performed as described below.

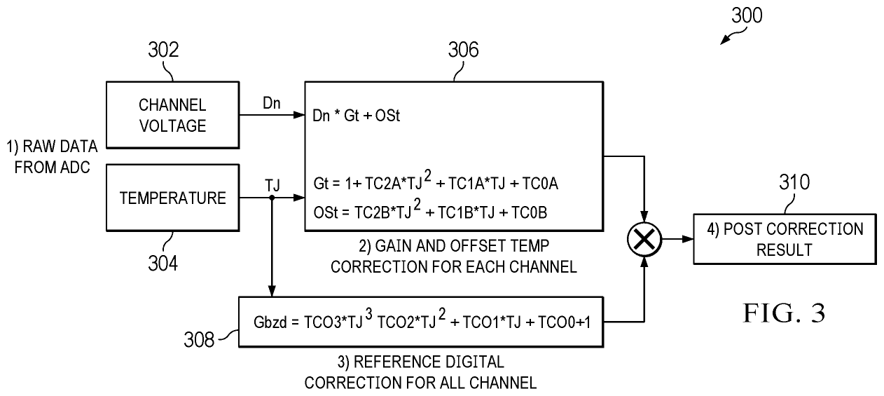

FIG. 3 is a block diagram 300 of a digital correction process in accordance with various examples herein. The digital correction process may be performed in digital controller 104 (FIGS. 1A and 1B) in one example. Any suitable hardware, software, firmware, or digital logic may perform digital correction in examples herein.

The analog correction described above using buried Zener diode 128 may still exhibit some temperature drift. Additional accuracy may be added in the digital domain. ADC 110 compares an analog input value from AFE 106 with the reference voltage provided by reference 112. ADC 110 provides a digital signal at its output. The digital output of ADC 110 is proportional to the ratio of analog input of ADC 110 and the reference voltage provided by reference 112. If the reference voltage provided by reference 112 has some error, then it may be corrected in the digital domain.

First, a channel voltage 302 is received from ADC 110. Each of N channels in ADC 110 produces an output value Dn. Dn is a channel voltage produced by a channel n. ADC 110 may introduce some gain error and some offset error. To remove the gain error, a gain correction factor (Gt) is multiplied by the digital output Dn. To correct the offset error, a value OSt is added to Dn. As shown in FIG. 3, a temperature 304 may also be received from temperature sensor 114 to perform the digital correction. Therefore, digital controller 104 may calculate Dn*Gt+OSt to correct the gain and offset errors.

The gain and offset errors may both be temperature dependent. Therefore, the Gt and OSt values used for the digital correction also depend on temperature. The Gt equation is equation (2):

$$Gt = 1 + TC 2 A * {TJ}^{2} + TC 1 A * TJ + TC 0 A \qquad ( 2 )$$

In equation (2), TJ is the temperature value from the temperature sensor 114. TC2A, TC1A, and TC0A are coefficients used to determine the gain correction. These coefficients are determined for each ADC 110 channel. Coefficients are determined based on raw ADC 110 readings taken during testing of the system. Coefficients based on these readings may be stored in one-time programmable registers. When a user uses the circuitry described herein, the digital controller 104 or another component loads the appropriate coefficients and performs the digital correction. In equation (2), the temperature value TJ is squared, so this is a second order correction.

The OSt equation is equation (3):

$$OSt = TC 2 B * {TJ}^{2} + TC 1 B * TJ + TC 0 B \qquad ( 3 )$$

TC2B, TC1B, and TCOB are coefficients used to determine the offset correction. These coefficients are also determined for each ADC 110 channel. The coefficients are also determined based on raw ADC 110 readings taken during testing of the system, like the gain coefficients described above. The offset coefficients based on these readings may also be stored in one-time programmable registers. As noted above, one example system has 18 channels corresponding to 18 battery cells. Each of the 18 ADCs 110 has its own error, and therefore gain and offset coefficients are stored for each of the 18 ADCs.

Correction 306 represents the gain and offset temperature correction performed for each channel, as described above. Correction 308 represents the digital correction for the reference voltage. The reference voltage error may be modeled with a third order polynomial, so the reference voltage correction uses a third order equation. Equation (4) provides the correction for the buried Zener diode reference Gbzd:

$$Gbzd = TCO 3 * {TJ}^{3} + TCO 2 * {TJ}^{2} + TCO 1 * TJ + TCO 0 + 1 \qquad ( 4 )$$

TCO3, TCO2, TCO1, and TCO0 are coefficients used to determine the reference voltage correction. These coefficients are also determined based on raw readings of the buried Zener diode based reference 112 taken during testing of the system. Each battery cell shares the same buried Zener diode reference 112, and therefore shares the same reference error. Therefore, the coefficient values in equation (4) are determined and stored once for the digital correction for each ADC channel. Equation (4) provides a third order correction. The corrections 306 and 308 are combined to produce a post-correction result 310.

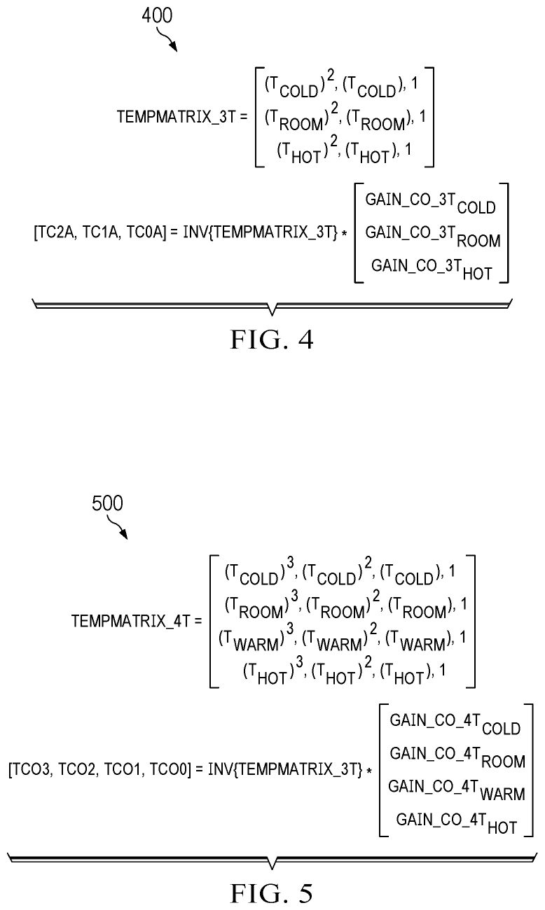

Any suitable method may be performed to generate the coefficients for the correction equations above. FIG. 4 is a second order digital correction 400 in accordance with various examples herein. Three data points are needed for a second order correction. The example in FIG. 4 shows how coefficients are generated for a second order correction of the digital output of ADC 110. In an example, the battery cell voltage readings are taken at three temperatures. The three temperatures may be cold, room, and hot temperatures. The specific temperature values may vary based on the product specifications. As one example, the three temperature values may be −40, 25, and 125 degrees Celsius. Other temperature values may be useful in other examples.

In this example, the nominal desired reference voltage V_{REF} is 4 V. Each battery cell measurement channel may have a different gain at each temperature. The gain for each channel is referred to as channel_gain. In an example, the channel_gain equals ADC_gain*REF_gain, where ADC_gain is the individual gain for each channel that may include error caused by random process variations in the ADC, and REF_gain is the gain related to the reference that is common to all channels. Therefore, REF_gain=4/V_{REF}, where 4 is the nominal reference voltage in volts, and V_{REF} is the voltage of the buried Zener diode based reference voltage (e.g., the voltage at node 252). In the first step of the digital correction, three ADC gain numbers are generated, one for each of the three temperatures (regardless of V_{REF}). Then, a gain error GAIN_CO_3T is calculated for each temperature with equation (5):

$$GAIN\_CO \_ 3 T = \frac{1}{ADC\_gain} - 1 \qquad ( 5 )$$

As shown in equation (5), if ADC_gain equals 1, there is no gain error. No gain correction would be performed in that example. If the gain is a value other than 1, then gain error is present, and the results above may be used for digital correction.

Equation (5) produces three gain error values, one for each temperature (GAIN_CO_3T_{cold}, GAIN_CO_3Tᵣₒₒₘ, and GAIN_CO_3Tₕₒₜ). Those gain error values may be curve fit into a second order polynomial to generate the three correction coefficients. A matrix TEMPMATRIX_3T performs this step. The 3×3 matrix TEMPMATRIX_3T is generated using the three temperatures, shown in FIG. 4. Then, an inverse matrix of this 3×3 matrix is performed to produce INV{TEMPMATRIX_3T}, as shown in FIG. 4. Next, a matrix multiplication is performed, represented by the * symbol, with the three numbers from the gain correction (e.g., GAIN_CO_3T_{cold}, GAIN_CO_3Tᵣₒₒₘ, and GAIN_CO_3Tₕₒₜ). A 3×3 matrix (INV{TEMPMATRIX_3T}) multiplied by a 3×1 matrix (the gain error values) produces a 3×1 result. The 3×1 result is represented in FIG. 4 by TC2A, TC1A, and TC0A. These three values are the three digital coefficients for the second order equation for the ADC related gain error correction Gt in FIG. 3.

In the second step of the digital correction, four reference relative gain numbers REF_gain are generated for each temperature. This gain is common for all the channels. FIG. 5 is a third order digital correction 500 in accordance with various examples herein. The process for the third order digital correction 500 is similar to the process described above with respect to FIG. 4, with an added data point. Four data points are needed for a third order correction. The example in FIG. 5 shows how coefficients are generated for a third order correction of the buried Zener diode based reference. In this example, the buried Zener diode based reference readings are taken at four temperatures. The three temperatures described above may be used (cold, hot, and room), with an added temperature, such as warm. Warm may be, for example, 85 degrees Celsius. The computations are then the same as described above with FIG. 4, except using a 4×4 matrix rather than a 3×3 matrix. FIG. 5 shows the TEMPMATRIX_4T and the 4×1 result. The 4×1 result produces four coefficients, such as TCO3, TCO2, TCO1, and TCO0 in FIG. 3.

The gain error value for the reference relative gain numbers is shown in equation (6):

$$GAIN\_CO \_ 4 T = \frac{1}{REF\_gain} - 1 \qquad ( 6 )$$

With the 2-step procedure described above, the overall gain correction for the channel is third order. In one example, the second step of digital correction is optional if the accuracy target is relaxed. In this case, equation (5) will include both ADC gain and reference related gain, as shown in equation (7):

$$GAIN\_CO \_ 3 T = \frac{1}{ADC\_gain * REF\_gain} - 1 \qquad ( 7 )$$

In this example, no reference voltage reading is needed, and TCO3, TCO2, TCO1, and TCO0 will all be zero. With this 1-step procedure, the overall gain correction for the channel is second order.

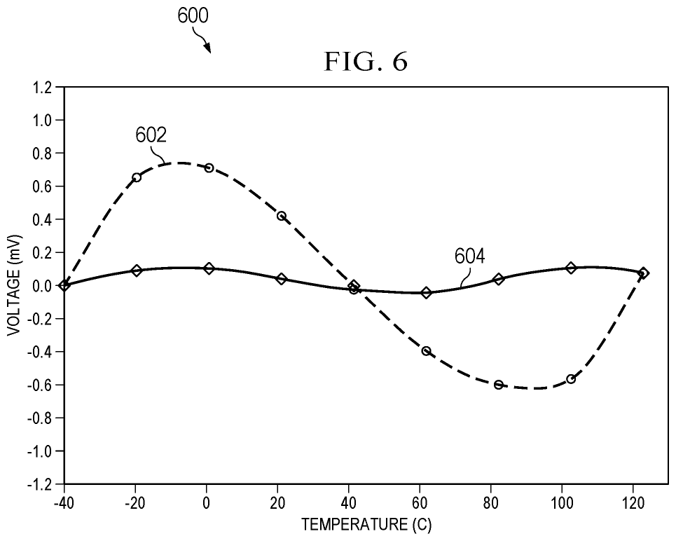

FIG. 6 is a graph 600 of reference related error in the channel digital reading after the 1-step second order correction in accordance with various examples herein. In graph 600, the y-axis represents the value of the reference related error in millivolts (mV) and the x-axis represents the temperature in Celsius. Graph 600 includes two curves 602 and 604. Curve 602 shows the difference between an actual temperature/voltage curve for a reference voltage and the curve fitting result as performed in accordance with various examples herein. Curve 602 shows the reference related error in the channel digital reading after the 1-step second order correction described herein. In this example, the curve fitting is performed at −40, 40, and 125 degrees Celsius, and therefore the errors at those 3 temperatures are zero mV. Curve 602 represents a second order correction performed for the channel digital reading. Curve 602 shows about a 1.3 mV peak-to-peak error across a temperature range of −40 to 120 degrees Celsius if a second order correction is performed.

Curve 604 is the reference related error in the channel digital reading after the two-step third order correction in accordance with various examples herein. Curve 604 shows the difference between an actual temperature/voltage curve for a reference voltage and the curve fitting result as performed in accordance with various examples herein. In this example, the curve fitting is done at −40, 25, 85, and 125 degrees Celsius, and therefore the errors at those four temperatures are zero mV. Curve 604 represents a third order correction performed for the buried Zener diode reference voltage. Curve 604 shows about a 0.2 mV peak-to-peak error across a temperature range of −40 to 120 degrees Celsius if a third order correction is performed.

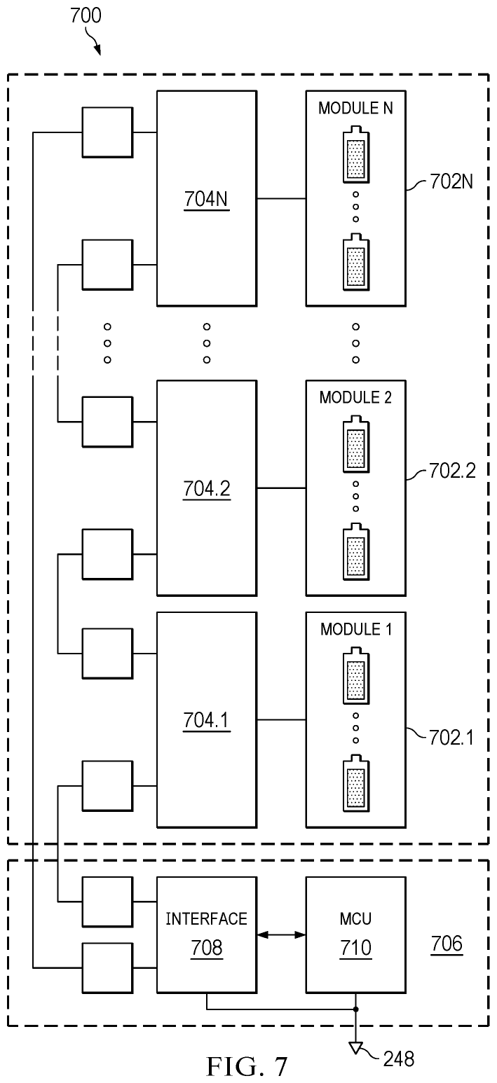

FIG. 7 is a block diagram of a battery monitoring system 700 in accordance with various examples herein. Battery monitoring system 700 includes multiple battery modules 702.1, 702.2, . . . 702N (referred to collectively as battery modules 702). Battery modules 702 may each have multiple battery cells, such as 18 battery cells each in one example. Battery monitoring system 700 includes multiple battery monitors 704.1, 704.2, . . . 704N (referred to collectively as battery monitors 704). Battery monitors 704.1, 704.2, . . . 704.N may each be a battery monitor 100 as described above in one example. Battery monitoring system 700 also includes a battery control unit (BCU) 706. Battery control unit 706 includes an interface 708 and a microcontroller unit (MCU) 710.

In battery monitoring system 700, each battery module 702 is monitored by a battery monitor 704. The battery monitors 704 may communicate in a daisy chain configuration and send signals to MCU 710 through interface 708. In examples herein, digital correction may be performed by a battery monitor 704 or by MCU 710.

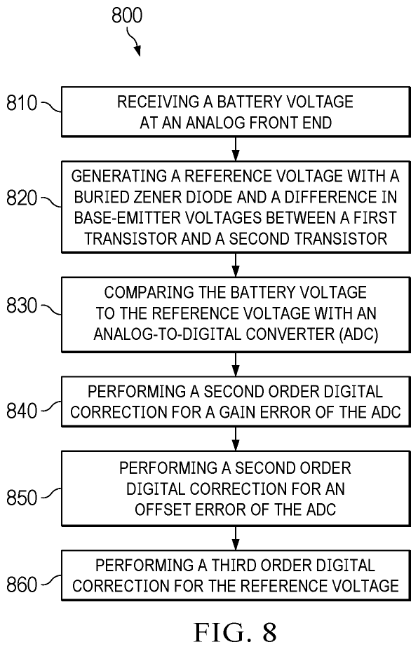

FIG. 8 is a flow diagram of a method 800 for performing digital correction of a voltage measurement channel using a buried Zener diode-based reference in accordance with various examples herein. The steps of method 800 may be performed in any suitable order. The hardware components described above with respect to FIGS. 1A, 1B, 2, and/or 7 may perform method 800 in some examples. Any suitable hardware, software, or digital logic may perform method 800 in some examples.

Method 800 begins at 810, where an AFE receives a battery voltage. The AFE may measure a voltage across a battery cell as described above. A battery monitoring system may include multiple AFEs and multiple battery cells.

Method 800 continues at 820, where a reference voltage is generated with a buried Zener diode and a difference in base-emitter voltages between a first transistor and a second transistor. As described above with respect to FIG. 2, a buried Zener diode, two BJTs, and a resistor network may generate a reference voltage that is largely resistant to temperature drift and less sensitive to package stress than a BJT-based bandgap voltage reference.

Method 800 continues at 830, where an ADC compares the battery voltage to the reference voltage. As described above, the ADC then produces a comparison (e.g., a digitized result) between these two inputs at its output. The digital output of the ADC may then be processed further in the digital domain to produce more accurate results.

Method 800 continues at 840, where a digital controller performs a second order digital correction for a gain error of the ADC. Three temperature readings may be useful for performing the second order digital correction.

Method 800 continues at 850, where a digital controller performs a second order digital correction for an offset error of the ADC. The three temperature readings may also be useful for performing this second order digital correction as described above.

Method 800 continues at 860, where a digital controller performs a third order digital correction for the reference voltage. The third order digital correction may use four temperature readings. With the examples herein, the reference related error after correction may be as small as 0.2 mV in some examples.

In examples herein, a battery monitor system is described that includes a combination of analog and digital circuitry. A buried Zener diode is used to provide a voltage reference. The buried Zener diode and the associated circuitry provides the analog portion of the system. The digital portion of the system includes performing a second order or third order digital correction. The combination of analog and digital circuitry provides improved temperature drift for the reference voltage. Also, a buried Zener diode has better resistance to package stress than a BJT because the buried Zener diode shifts less than the BJT reference after being packaged and soldered down.

In this description, the term “couple” may cover connections, communications or signal paths that enable a functional relationship consistent with this description. For example, if device A provides a signal to control device B to perform an action, then: (a) in a first example, device A is directly connected to device B; or (b) in a second example, device A is coupled to device B through intervening component C if intervening component C does not alter the functional relationship between device A and device B, so device B is controlled by device A via the control signal provided by device A.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

A circuit or device that is described herein as including certain components may instead be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be coupled to at least some of the passive elements and/or the sources to form the described structure either at a time of manufacture or after a time of manufacture, for example, by an end-user and/or a third-party.

While certain components may be described herein as being of a particular process technology, these components may be exchanged for components of other process technologies. Circuits described herein are reconfigurable to include the replaced components to provide functionality at least partially similar to functionality available prior to the component replacement. Components shown as resistors, unless otherwise stated, are generally representative of any one or more elements coupled in series and/or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter. Modifications are possible in the described examples, and other examples are possible within the scope of the claims.

What is claimed is:

1. A system, comprising:
a buried Zener diode having a first terminal coupled to a voltage terminal;
a first resistor having a first terminal coupled to a second terminal of the buried Zener diode;
a second resistor having a first terminal coupled to a second terminal of the first resistor;
a first transistor having a control terminal coupled to the first terminal of the second resistor;
a second transistor having a control terminal coupled to a second terminal of the second resistor and an emitter coupled to an emitter of the first transistor; and
a resistor network coupled to the second terminal of the first resistor, wherein the resistor network is configured to produce a reference voltage.

2. The system of claim 1, wherein the second resistor is configured to produce a difference between base-emitter voltages of the first transistor and the second transistor.

3. The system of claim 1, wherein the reference voltage is a buried Zener diode based voltage reference.

4. The system of claim 1, wherein the resistor network includes a resistor divider configured to produce the reference voltage.

5. The system of claim 1, wherein the resistor network is configured to produce the reference voltage between a third resistor and a fourth resistor.

6. The system of claim 5, wherein the third resistor and the fourth resistor are variable resistors configured to produce the reference voltage.

7. The system of claim 1, wherein the first transistor and the second transistor are bipolar junction transistors.

8. The system of claim 1, wherein a current mirror is coupled to the emitter of the first transistor and the emitter of the second transistor.

9. The system of claim 1, wherein a current mirror is coupled to a collector of the first transistor.

10. A system, comprising:
an analog front end configured to receive a battery voltage;
a reference voltage generator configured to generate a reference voltage with a buried Zener diode and a difference in base-emitter voltages between a first transistor and a second transistor;
an analog-to-digital converter (ADC) configured to receive the battery voltage and compare the battery voltage to the reference voltage to produce a digitized result; and
a controller configured to receive the digitized result from the ADC and perform a digital correction, wherein the digital correction includes a gain correction and an offset correction of the ADC, and wherein the digital correction includes a correction for the reference voltage.

11. The system of claim 10, wherein the digital correction includes a second order correction for the gain correction and the offset correction of the ADC, and includes a third order correction for the reference voltage.

12. The system of claim 10, wherein the digital correction includes a third order correction for the reference voltage.

13. The system of claim 10, wherein the first transistor and the second transistor are bipolar junction transistors.

14. The system of claim 10, wherein the reference voltage generator includes a resistor network configured to produce the reference voltage.

15. The system of claim 10, wherein the controller includes a low pass filter.

16. A method, comprising:
receiving a battery voltage at an analog front end;
generating a reference voltage with a buried Zener diode and a difference in base-emitter voltages between a first transistor and a second transistor;
comparing the battery voltage to the reference voltage with an analog-to-digital converter (ADC);
performing a second order digital correction for a gain error of the ADC;
performing a second order digital correction for an offset error of the ADC; and
performing a third order digital correction for the reference voltage.

17. The method of claim 16, wherein the second order digital correction for the gain error and the second order digital correction for the offset error include three temperature readings.

18. The method of claim 16, wherein the third order digital correction for the reference voltage includes four temperature readings.

19. The method of claim 16, wherein the buried Zener diode includes a first terminal coupled to a voltage terminal and a second terminal coupled to a resistor.

20. The method of claim 19, wherein the resistor is coupled to a resistor network to produce the reference voltage.
